(19) United States
(12) Patent Application Publication
(10) Pub. No.: US 2024/0413549 A1
(43) Pub. Date: Dec. 12, 2024

(54) CONDUCTOR TERMINAL

(71) Applicant: WAGO Verwaltungsgesellschaft mbH, Minden (DE)

(72) Inventors: Jakob SCHELLENBERG, Porta Westfalica (DE); Viktor MICKMANN, Wunstorf (DE)

(73) Assignee: WAGO Verwaltungsgesellschaft mbH, Minden (DE)

(21) Appl. No.: 18/806,657

(22) Filed: Aug. 15, 2024

Related U.S. Application Data
(63) Continuation of application No. PCT/EP2023/053764, filed on Feb. 15, 2023.

(30) Foreign Application Priority Data
Feb. 16, 2022 (DE) 10 2022 103 633.2

(51) Int. Cl. H01R 9/24; H01R 11/09

(52) U.S. Cl. CPC H01R 9/2416; H01R 11/09

(57) ABSTRACT

A conductor terminal in the form of a distribution terminal block, which comprises a housing with a number of conductor insertion openings and spring-loaded clamping connections arranged in the housing and accessible via the conductor insertion openings for the purpose of connection of electrical conductors. The spring-loaded clamping connections being electrically conductively interconnected via a bus bar arrangement.

This nonprovisional application is a continuation of International Application No. PCT/EP2023/053764, which was filed on Feb. 15, 2023, and which claims priority to German Patent Application No. 10 2022 103 633.2, which was filed in Germany on Feb. 16, 2022, and which are both herein incorporated by reference.

### BACKGROUND OF THE INVENTION

### Field of the Invention

The invention relates to a conductor terminal, e.g., in the form of a distribution terminal block, which comprises a housing with a number of conductor insertion openings and spring-loaded clamping connections arranged in the housing and accessible via the conductor insertion openings for the purpose of connection of electrical conductors, wherein the spring-loaded clamping connections are electrically conductively interconnected via a bus bar arrangement.

### Description of the Background Art

A conductor terminal is known from EP 2 456 011 B1, which corresponds to US 2012/0196459, which is incorporated herein by reference.

### SUMMARY OF THE INVENTION

It is therefore an object of the invention to further improve a conductor terminal.

A distribution terminal block is used to distribute an electrical signal or electrical energy fed into the distribution terminal block via an electrical line to a number of electrical lines also connected to the distribution terminal block, which as a rule have a smaller cross-section than the electrical line supplying the signal or electrical energy.

At least one clamping spring of a spring-loaded clamping connection can be supported by at least one mandrel, which ends in a spring arc of the clamping spring with at least one head section and extends to a support point on the housing which lies outside the spring arc, wherein at least the head section protrudes laterally beyond the edge of the spring arc and is received and supported in a receiving groove of part of the housing. Such a mandrel allows for advantageous support of the clamping spring, so that it is held securely in the housing even with large forces. Because the head section protrudes laterally beyond the edge of the spring arc and is received and supported in a receiving groove of part of the housing, the mandrel can also be stabilized in turn, which makes it possible to design it less massively and, accordingly, with less material cost. In addition, the clamping spring can be advantageously supported on the side edge. In this way, the head section is held securely by a kind of tongue-and-groove connection. The part of the head section received in the receiving groove of the housing can, for example, be received in a form-fitting manner, i.e., fit snugly on the inside of the receiving groove.

At least one clamping spring of a spring-loaded clamping connection can be supported by at least one mandrel which ends with at least one head section in a spring arc of the clamping spring and extends up to a support point on the housing, which lies outside the spring arc, wherein at least two head sections of the same mandrel or two different mandrels spaced apart from each other extend into the spring arc of the clamping spring and support it. In this way, the clamping spring can be symmetrically supported on both sides at its lateral edge areas by such head sections. The head sections protruding laterally beyond the edge of the spring arc on both sides may each be received and supported in a respective receiving groove of a part of the housing, as explained above.

The bus bar arrangement can have at least one retaining tab for holding at least one clamping spring, the retaining tab having at least one lateral retaining plate which is received in retaining grooves of at least part of the housing for support. This can also provide an advantageous holder for a clamping spring. The bus bar arrangement acts as a mounting mechanism, i.e., the retaining tab is part of the bus bar arrangement and accordingly formed as a sub-area of a bus bar component or connected to such a bus bar component. The retaining tab can be made of metal material, e.g., the same material as the bus bar component or another metal material. In particular, the retaining tab can have a lateral retaining plate each on opposite sides which are each received in an assigned retaining groove of at least part of the housing for support. In this way, too, a tongue-and-groove connection can be provided to support the retaining tab.

The invention thus allows for the realization of a conductor terminal with a simple, compact design, simple arrangement and the arrangement of the components in only one arrangement direction. The conductor terminal has relatively few simple components, so that arrangement is connected with little effort. In addition, the conductor terminal can be realized cost-effectively. The features a), b), c) mentioned above can be realized individually or in any combination.

For example, the housing can be designed as an essentially cuboid housing. The housing can be formed in exactly two parts, that is, only have a first and second housing part. The first housing part can be connected to the second housing part, for example via a latching connection. For example, the housing can have a lower housing part and a top housing part. The top housing part may be formed as a cap which can be pulled over the top housing part and then overlaps a significant part of the side walls of the lower housing part. The part of the housing mentioned above may be the top housing part, for example.

The two head sections which are spaced from each other and which are arranged within the same spring arc, can each be arranged on opposite sides laterally on the edge of the spring arc or protrude beyond the edge of the spring arc. This allows for the clamping spring to be particularly securely supported by the head sections.

At least one head section projecting laterally beyond the edge of the spring arc of a clamping spring can extend into the spring arc of an adjacent clamping spring and supports it. In this way, one and the same head section of a mandrel can be used twice. Particularly in the case of a conductor terminal with a large number of spring-loaded clamping connections, in which the terminals are supported by such head sections, there is a significant streamlining effect. For example, if n clamping springs are placed in a row next to each other and are supported by such common head sections, it is, e.g., sufficient to use n−1, n or n+1 head sections. In an advantageous embodiment, there is an intermediate space between the edge of the spring arc of one clamping spring and the edge of the spring arc of the adjacent clamping spring, in which the head section is exposed. In this area, the head section can be accommodated for support in a retaining groove of at least part of the housing.

The retaining tab ends in a spring arc of the clamping spring and can extend up to a support point on the bus bar arrangement which lies outside the spring arc. Accordingly, the retaining tab, similar to the mandrel, can be comparatively elongated and extend, for example, along an attachment leg of the clamping spring.

The retaining tab with its at least one lateral retaining plate can protrude beyond the edge of the spring arc. This has the advantage that the lateral retaining plate or the two lateral retaining plates, if they protrude beyond the edge of the spring arc, can be easily accommodated in a retaining groove of a part of the housing. In particular, the part of the housing having the retaining groove does not have to protrude into the space surrounded by the spring arc.

In the case of one, a number of or all clamping springs, the free end of the attachment leg can be supported on a support contour of the bus bar arrangement, especially when the clamping spring is deflected. This allows for a self-supporting design of a spring-loaded clamping connection to be realized. The forces acting on the housing are thus minimized.

At least one clamping spring can be supported by means of a support structure, which contains at least two superimposed and interconnected layers of metal components, e.g., sheet metal parts. Such metal components can be used to create particularly stable support of a clamping spring. Such support is particularly useful for large, cross-sectional spring-loaded clamping connections, because this is where particularly strong clamping springs are used. Here, for example, one layer of the metal components can be formed by a bus bar component, a second layer of the metal components by a component with the retaining tab. The layers of metal components can be interconnected, for example, by means of a joint, e.g., by riveting, welding, or press joining.

The bus bar component can be formed in one piece from a sheet metal coating. At least one of the two metal layers can be bent around two mutually perpendicular bending axes. This results in an overall stiffening of the bus bar component.

The at least two layers of metal components superimposed and interconnected can lie flat against each other in a plane that runs perpendicular to the conductor insertion direction of the spring-loaded clamping connection. At least part of the support structure may be located below the spring arc of the clamping spring and/or extend into the spring arc of the clamping spring. This allows for particularly robust support of the clamping spring.

One, a number of or all the mandrels may extend through at least one opening in the bus bar arrangement. This has the advantage that the mandrels can be designed in a simple way in one piece with a part of the housing, e.g., the lower housing part. The mandrels also ensure that the bus bar arrangement is fixed in the housing.

The conductor insertion openings can have at least one large cross-section conductor insertion opening and a number of small cross-section conductor insertion openings which are present in larger numbers than the at least one large cross-section conductor insertion opening, wherein the at least one large cross-section conductor insertion opening has a larger cross-section than the small cross-section conductor insertion openings. In this way, the available space on the conductor connection side of the housing can be used in the best possible way. Accordingly, only the smaller conductor insertion openings are required for the connection of small cross-section conductors. For the at least only one large cross-section conductor insertion opening, the large space requirement is thus only required once, or at least only a few times on the conductor connection side.

The mandrel can be molded in one piece with at least one part of the housing. For example, the mandrel can be produced with the part of the housing in a plastic injection molding process. This has the advantage that the mandrel is not available as a separate component and does not have to be mounted separately. Already through the production of the housing part, the mandrel is arranged in the desired, correct place.

The mandrel can also be designed in multiple parts, or as a separate component from the housing. The mandrel can be made of plastic, metal or any other material. The mandrel may also be formed as part of the bus bar arrangement or attached to the bus bar arrangement.

The housing of the conductor terminal, in particular the second part of the housing, may have an assigned actuation channel for each spring-loaded clamping connection, in which an actuator is arranged for opening the clamping point of the spring-loaded clamping connection, for example a actuating button. In an advantageous embodiment, the manual operating surfaces of the actuating buttons may be located on the conductor connection side of the conductor terminal. This allows for easy operation of the spring-loaded clamping connections for inserting and removing electrical conductors.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in perspective view;

FIG. 2 shows the conductor terminal according to FIG. 1 in a plan view of the conductor connection side;

FIG. 3 shows a bus bar arrangement in perspective view;

FIG. 4 shows the bus bar arrangement according to FIG. 3 with attached clamping springs;

FIG. 5 shows a lower housing part in perspective view;

FIG. 6 shows the lower housing part according to FIG. 5 with the arrangement according to FIG. 4;

FIG. 7 shows the conductor terminal according to FIG. 2 in the cross-sectional view B-B;

FIG. 8 shows the conductor terminal according to FIG. 7 in the cross-sectional view D-D;

FIG. 9 shows the conductor terminal according to FIG. 2 in the cross-sectional view H-H;

FIG. 10 shows the conductor terminal according to FIG. 2 in the cross-sectional view A-A;

FIG. 11 shows the conductor terminal according to FIG. 10 in the cross-sectional view C-C; and

FIG. 12 shows a top housing part in perspective cross-sectional view.

### DETAILED DESCRIPTION

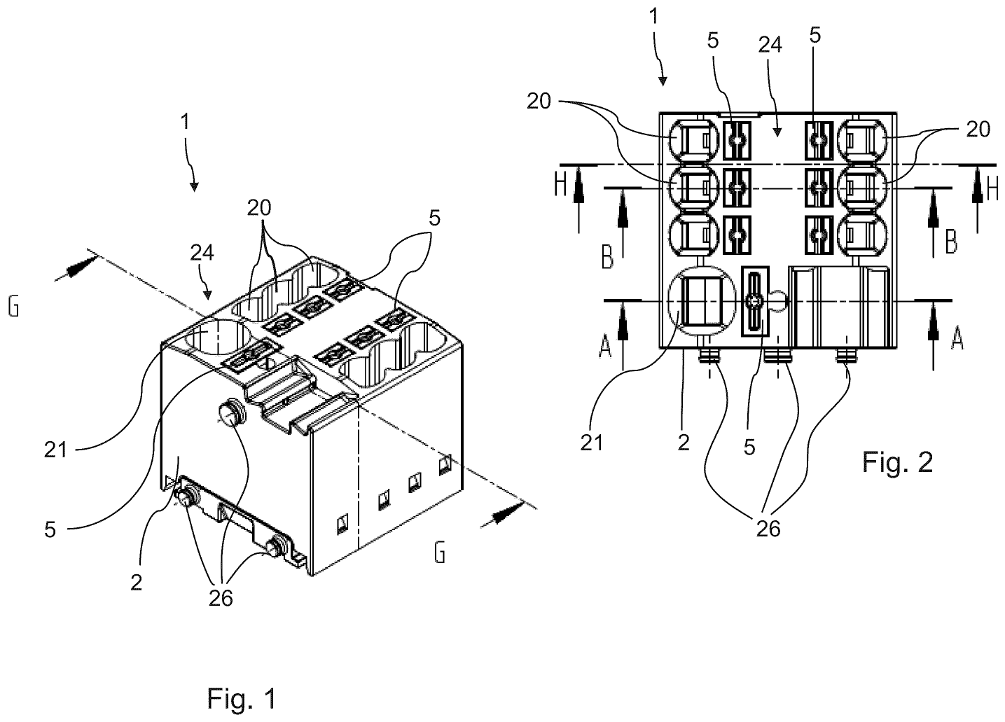

FIG. 1 shows a conductor terminal 1 in the form of a distribution terminal block, which has a housing 2 with a number of conductor insertion openings 20, 21. In the embodiment examples, all conductor insertion openings 20, 21 are arranged on a conductor connection side 24 of the housing 2. From the conductor connection side 24, actuators 5, which extend into the interior of the housing 2, are also accessible from the outside. The spring-loaded clamping connections arranged in the housing 2 can be operated manually via actuators 5. Electrical conductors can be inserted into the housing 2 through conductor insertion openings 20, 21 and be clamped to the spring-loaded clamping connections.

FIG. 2 shows the conductor terminal 1 in a plan view of the conductor connection side 24. It can be seen that the conductor insertion openings 20, 21 have different sizes, i.e., different cross-sections. In the embodiment example shown, there are a number of (here six) small cross-section conductor insertion openings 20 and a large cross-section conductor insertion opening 21. Due to their size, only electrical conductors with a smaller cross-section can be inserted into the small cross-section conductor insertion openings 20 and attached to small cross-section spring-loaded clamping connections than into the large cross-section conductor insertion opening 21. The large cross-section conductor insertion opening 21 is used to connect a large cross-section electrical conductor to a large cross-section spring-loaded clamping connection via which electrical energy or electrical signals are fed into or discharged from the conductor terminal 1.

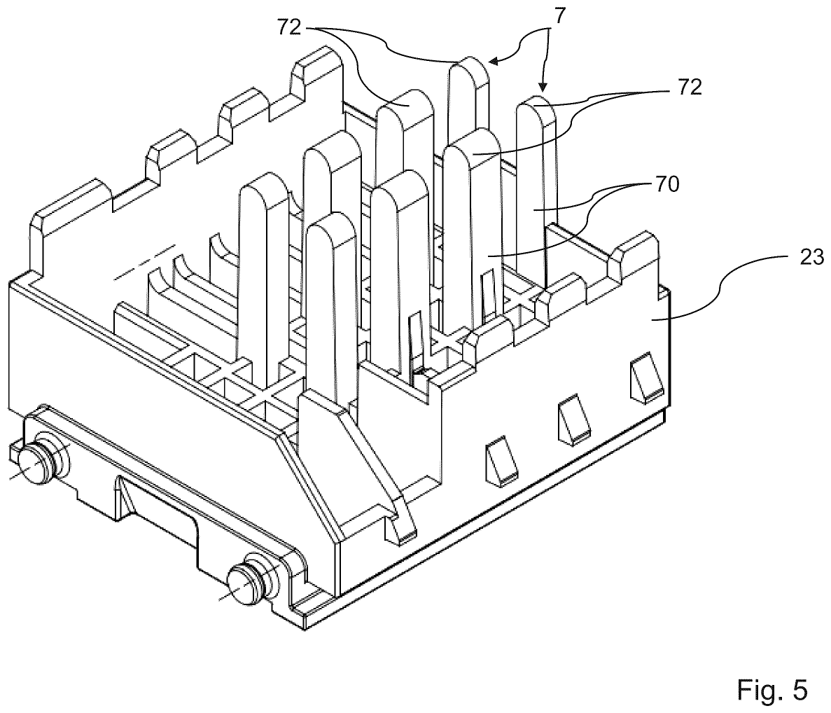

As can also be derived from FIGS. 1 and 2, at least one coupling element 28 can be arranged on the outer side of the housing 2, e.g., on a lower housing part 23 (corresponding to FIG. 5), e.g., in that the coupling element 28 is molded to the corresponding housing part in one piece. The housing 2 can have a corresponding counterpart to the coupling element 28 on the side of the housing opposite the coupling element 28. For example, the coupling element 28 can be designed as a protruding pin or latching element, in which case the counterpart can be formed on the opposite side of the housing as a recess or indentation in the housing. The coupling element 28, in connection with its counterpart, can form-fittingly interconnect a number of conductor terminals 1 to the outer sides of the housing in order to form a distribution strip.

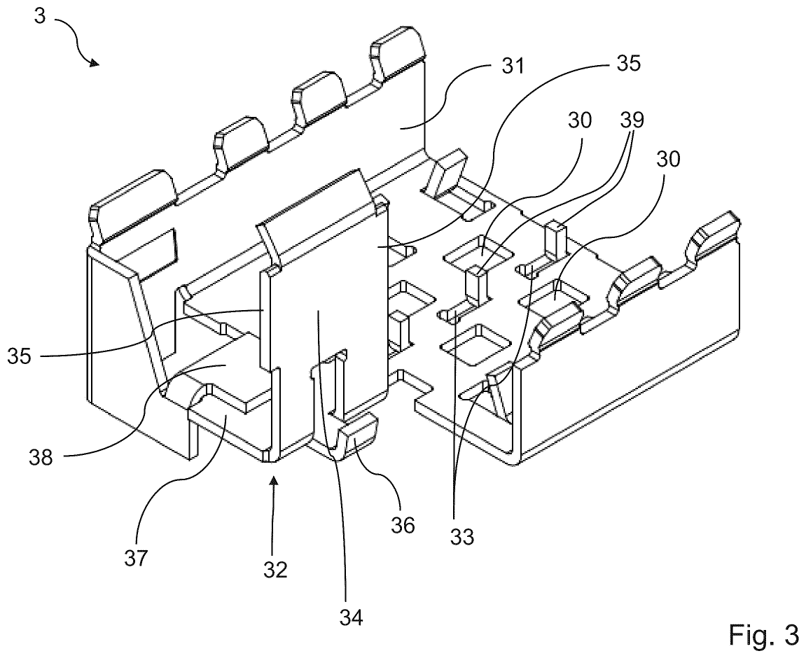

The conductor terminal 1 has a bus bar arrangement 3 disposed in the housing 2, which is shown in FIG. 3. The bus bar arrangement 3 comprises a bus bar component 31 and a spring support element 32 attached to the bus bar component 31. The bus bar component 31 is used for the electrical transmission of current between the various spring-loaded clamping connections of the conductor terminal 1. The bus bar component 31 can be molded as a one-piece component. This ensures an optimal flow of current between the spring-loaded clamping connections and also saves production steps. The bus bar component 31 also has a mechanical support function for the clamping springs of at least some spring-loaded clamping connections. For this purpose, the bus bar component 31 has a number of protruding pins 39, which can be formed, for example, from the material of the bus bar component 31 by separating material from it by means of a forming process, which forms the pins in each case. This creates an opening 33 in the bus bar component 31 in the vicinity of a pin 39.

The spring support element 32 is used to support one of the clamping springs of the conductor terminal 1. The spring support element 32 has a fastening section 37 with which it is attached to a retaining section 38 of the bus bar component 31. The spring support element 32 also has a retaining tab 34, which, e.g., is arranged essentially at right angles to the fastening section 37. The retaining tab 34 extends into a spring arc of the clamping spring to be supported. The retaining plates 35 protrude from the sides of the retaining tab 34. In addition, the spring support element 32 has a connecting section 36 extending from the fastening section 37 beyond the retaining tab 34 and protruding therefrom, with which an attachment leg of the clamping spring to be supported can be coupled to the spring support element 32 in a form-fitting manner.

The bus bar component 31 also has openings 30, through which mandrels can extend as explained below.

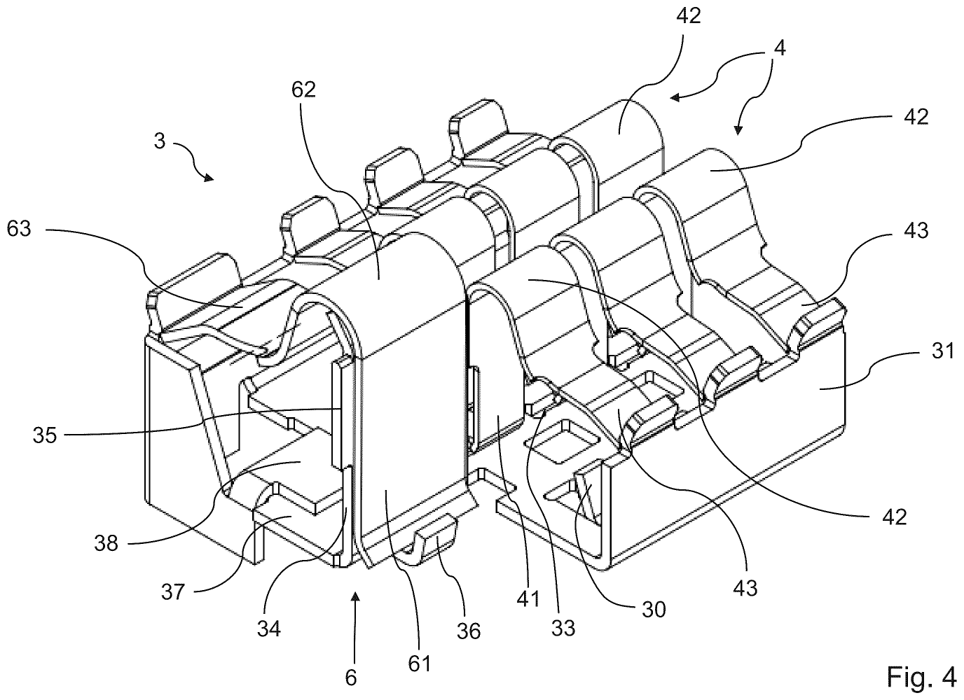

FIG. 4 shows the bus bar arrangement 3 with clamping springs 4, 6 attached to it. For the small cross-section spring-loaded clamping connections, there are respective clamping springs 4, for the large cross-sectional spring-loaded clamping connection a clamping spring 6. The clamping spring 6 is correspondingly larger than the clamping springs 4. All clamping springs 4, 6 have an attachment leg 41, 61 each. A spring arc 42, 62 is attached to the attachment leg. The spring arc 42, 62 is followed by a clamping leg 43, 63. The attachment leg 41, 61 is used to attach the clamping spring and support against the clamping force of the clamping leg 43, 63. The spring arc 42, 62 provides the required elasticity of the clamping spring. The spring arc 42, 62 is therefore subject to the greatest changes in shape when the clamping leg is deflected, e.g., when the clamping point is opened.

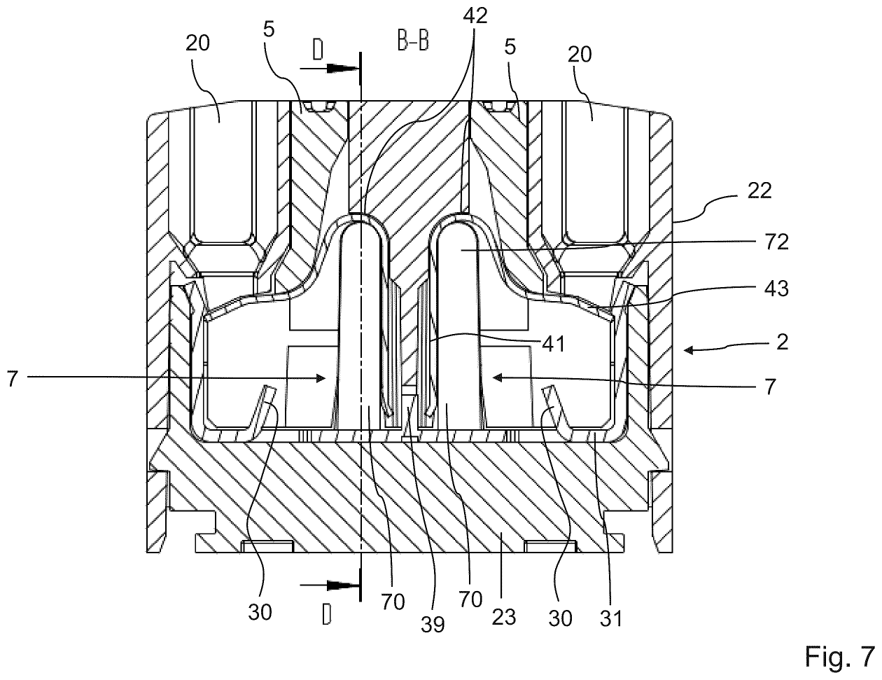

The free ends of the attachment legs 42 are bent advantageously in a direction away from the clamping legs 43. The clamping legs 43, 63 form a clamping point for the clamped electrical conductor(s) with a part of the bus bar component 31 angled in the opposite direction of the conductor insertion. Furthermore, the base of the bus bar component 31, i.e., the section which is aligned perpendicular to the direction of the conductor insertion, has the exposed stop tabs 30 as a stop/overload stop for the clamping legs 43, 63. The attachment legs 41 can be supported on the pins 39, which will be explained below on the basis of FIG. 7. The attachment leg 61 is held on one side by the retaining tab 34 and on the opposite side by the connecting section 36. In addition, the entire clamping spring 6 is supported by the retaining tab 34 by the fact that the retaining tab 34 extends inside the spring arc up to the material of the clamping spring 6 and rests against it. It can also be seen that the lateral retaining plates 35 protrude laterally from the clamping spring 6.

FIG. 5 shows a lower part 23 of the housing 2 without any other elements of the conductor terminal 1 attached to it. It can be seen that in the middle and partly also at the edge of the lower housing part 23, protruding mandrels 7 are present. The mandrels 7 are attached to the lower housing part 23 at a lower base section 70 or are molded in a single piece with it. The mandrels 7 extend towards the free end towards a respective head section 72, which serves to support the clamping spring 4, as will be explained below. It is recognizable that the mandrels 7 in the embodiment example shown have different widths, but they can also be designed with the same width.

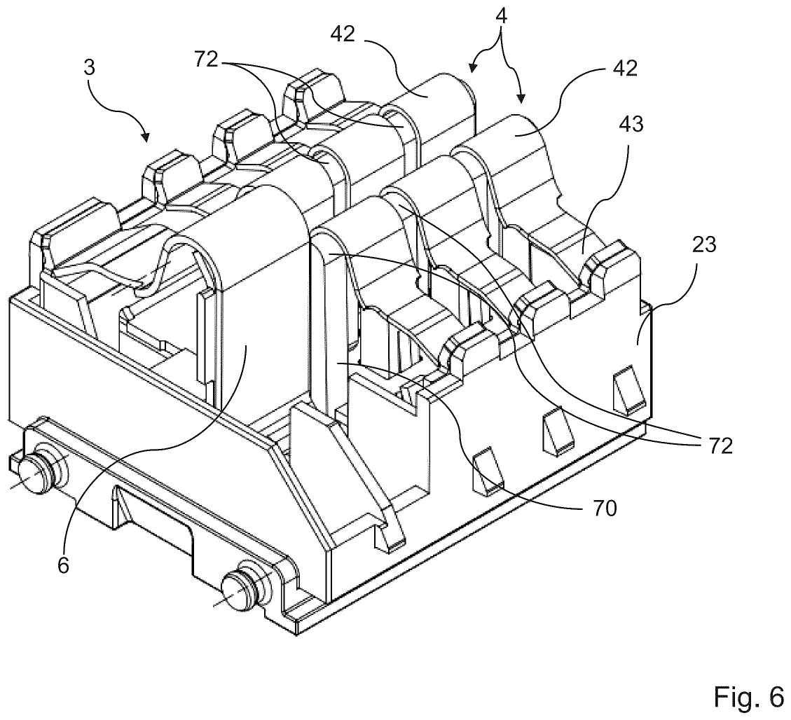

FIG. 6 shows the lower housing part 23 with the arrangement attached to it formed of the bus bar arrangement 3 and the clamping springs 4, 6. It can be seen that the mandrels 7 now extend into the respective spring arcs 42 with their head sections 72, which have a rounding at the free end, and rest there. There is a free space between the spring arcs 42 of the adjacent clamping springs, which are arranged in a row, which is bridged by at least one of the head sections 72 arranged in the middle. In this case, such a head section 72 extends from the spring arc 42 of one clamping spring to the spring arc 42 of the adjacent clamping spring. In this way, the mandrels 7 in the middle with their respective head sections 72 act as support elements for two adjacent clamping springs 4 each.

The cross-sectional representation of FIG. 7 illustrates the support of the clamping springs 4 by the respective mandrel 7, in that the head section 72 of the mandrel 7 extends into the spring arc 42 and is at least partially in contact. The attachment leg 42 of the clamping spring 4 can advantageously be in contact with the mandrel 7 for at least the largest part of its extension. In addition, in the deflected state of the clamping spring 4, the free ends of the attachment legs 41 can be supported on the pins 39 exposed from the material of the openings 33. A pin 39 serves as a support for two clamping springs 4 opposite each other.

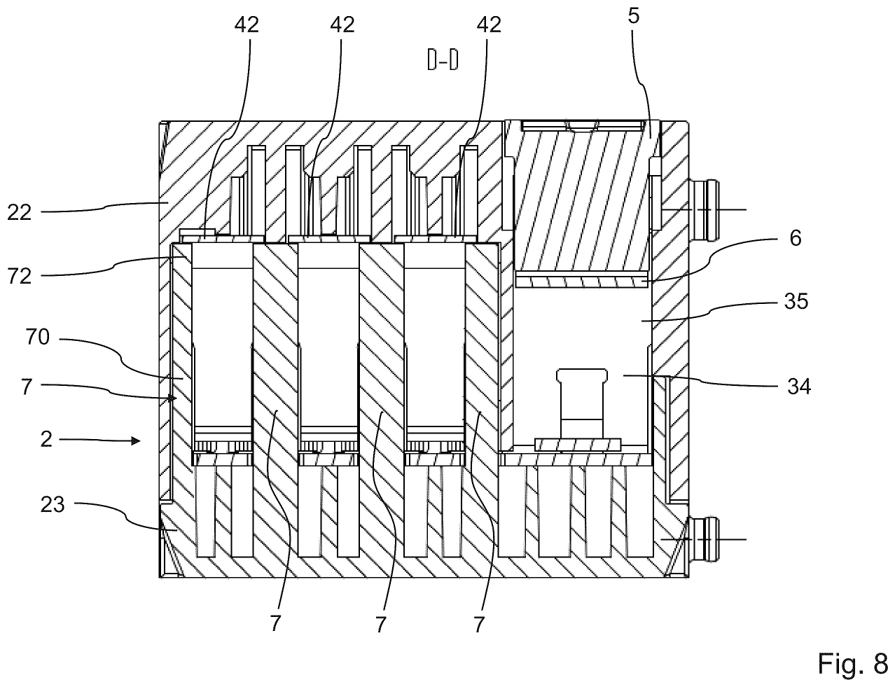

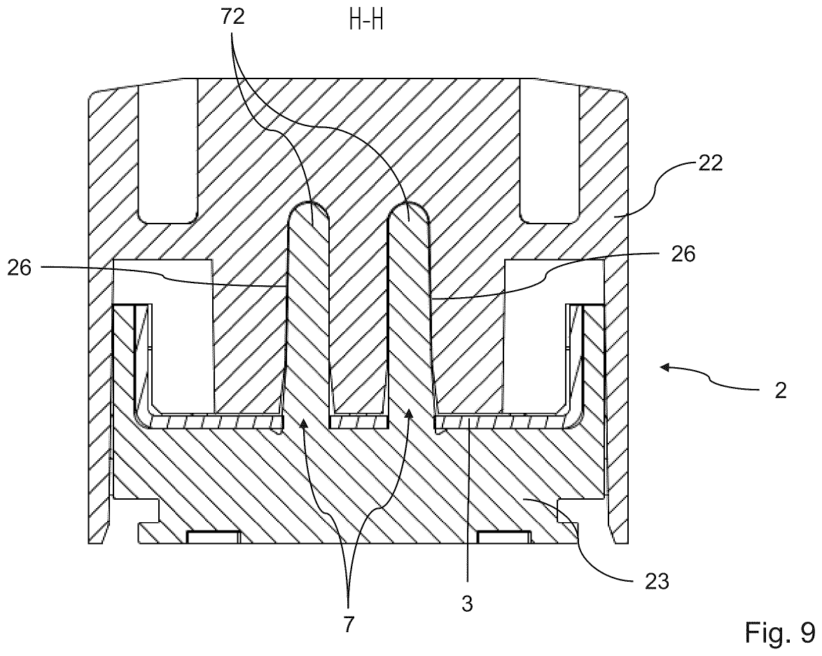

FIG. 8 illustrates that the respective outer mandrels 7 support the respective outer clamping spring 4 or the spring arc 42 on one side. The middle mandrels 7 support in each case two adjacent spring arcs 42 at the lateral edge.

The cross-sectional representation of FIG. 9 makes it clear that, when the top housing part 22 is attached, the areas of the head sections 72 and partly also of the base sections 70 of the mandrels 7, which protrude laterally beyond the clamping springs 4, are form-fittingly received and thus supported in a receiving groove 26 of the top housing part 23 adapted to their size.

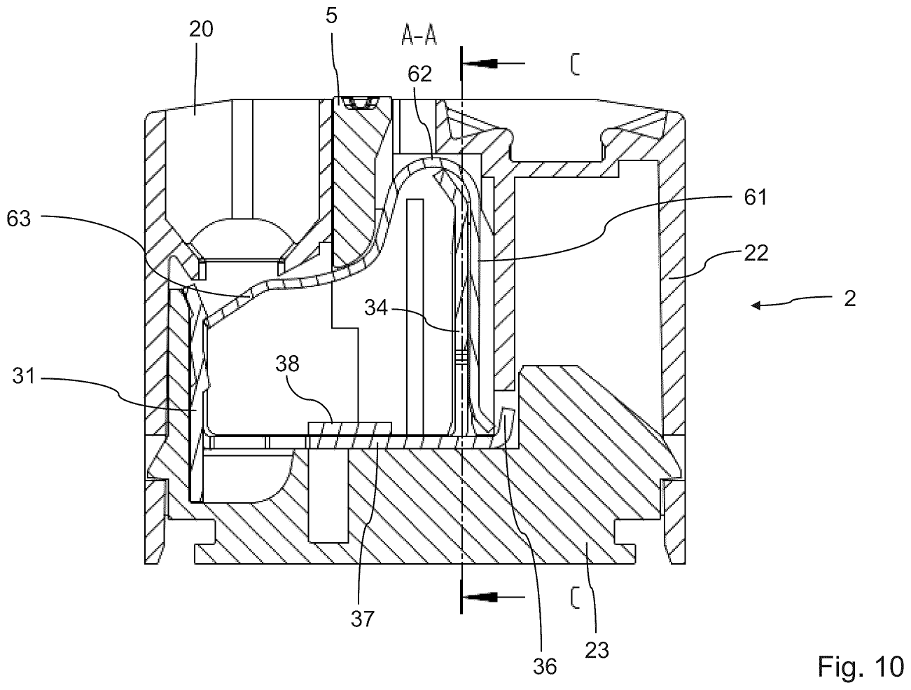

The cross-sectional representation of FIG. 10 illustrates the design of the spring-loaded clamping connection with the large cross-section. In particular, the position and fixation of the clamping spring 6 by means of the retaining tab 34 and the connecting section 36 are highlighted. The attachment leg 63 can advantageously be in flat contact along a substantial part of its extension on the retaining tab 34.

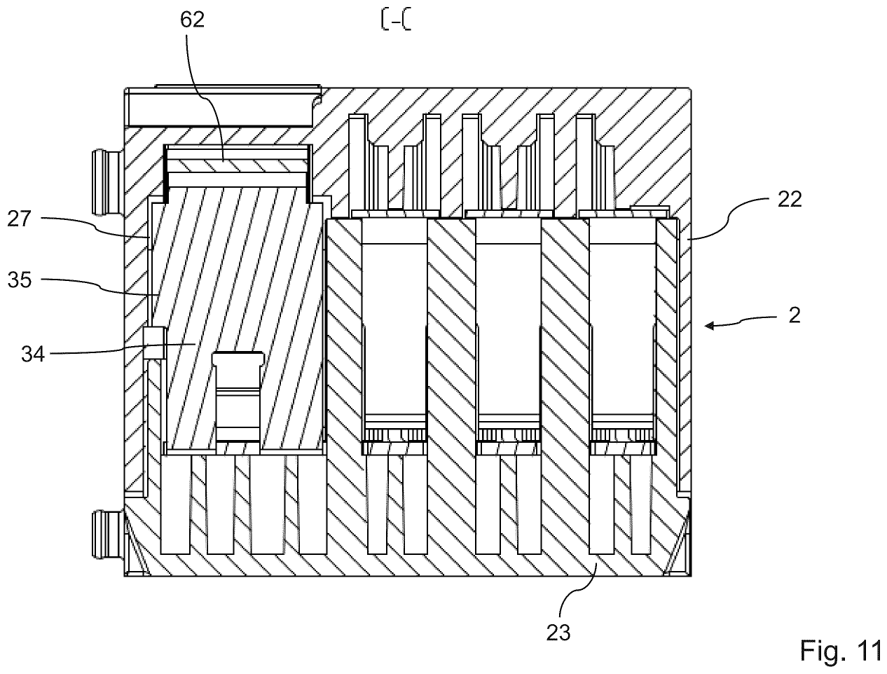

FIG. 11 illustrates the fixation and support of the retaining tab 34 by the lateral retaining plates 35, each of which engages in a retaining groove 27 of the top housing part 22 and is included in it in a form-fitting manner.

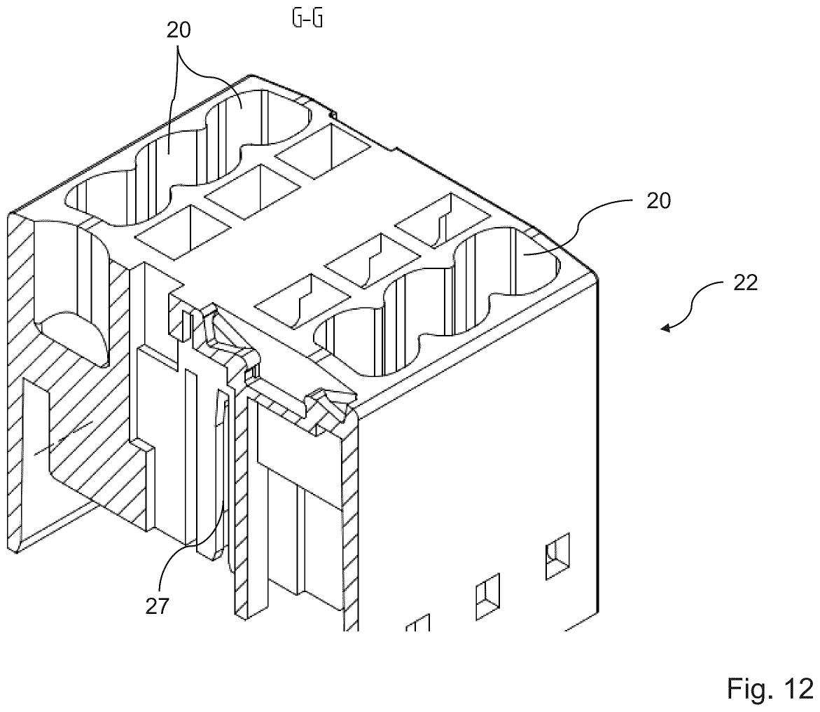

On the basis of the cross-sectional representation, FIG. 12 shows a possible embodiment of such a retaining groove 27 for receiving a lateral retaining plate 35.

What is claimed is:

1. A conductor terminal comprising:
a housing with at least two conductor insertion openings; and
at least two spring-loaded clamping connections arranged in the housing and accessible via the conductor insertion openings to connect electrical conductors, the spring-loaded clamping connections being electrically conductively interconnected by a bus bar arrangement comprising one, a number of or all of the following features (a), (b), (c):
a) at least one clamping spring of a spring-loaded clamping connection is supported by at least one mandrel, which ends with at least one head section in a spring arc of the clamping spring and extends to a support point on the housing which is located outside of the spring arc, at least the head section protruding laterally beyond the edge of the spring arc and is received and supported in a receiving groove of a part of the housing;
b) at least one clamping spring of a spring-loaded clamping connection is supported by at least one mandrel, which ends with at least one head section in a spring arc of the clamping spring and extends to a support point on the housing, which lies outside the spring arc, at least two head sections of the same mandrel being spaced from each other or two different mandrels extending into the spring arc of the clamping spring and support such; and/or
c) the bus bar arrangement has at least one retaining tab for holding at least one clamping spring, the retaining tab having at least one lateral retaining plate which is received in retaining grooves of at least part of the housing for support.

2. The conductor terminal according to claim 1, wherein the two head sections spaced from each other, which are arranged within the same spring arc, are disposed on opposite sides each laterally at the edge of the spring arc or protrude beyond the edge of the spring arc.

3. The conductor terminal according to claim 1, wherein at least one head section protruding laterally beyond the edge of the spring arc of a clamping spring extends into the spring arc of an adjacent clamping spring and supports it.

4. The conductor terminal according to claim 1, wherein the retaining tab ends in a spring arc of the clamping spring and extends to a support point on the bus bar arrangement which lies outside the spring arc.

5. The conductor terminal according to claim 4, wherein the retaining tab, with its at least one lateral retaining plate, protrudes beyond the edge of the spring arc.

6. The conductor terminal according to claim 1, wherein, in the case of one or a number of all clamping springs, the free end of the attachment leg is supported on a support contour of the bus bar arrangement when the clamping spring is deflected.

7. The conductor terminal according to claim 1, wherein at least one clamping spring is supported by a support structure which has at least two superimposed and interconnected layers of metal components.

8. The conductor terminal according to claim 7, wherein the at least two superimposed and interconnected layers of metal components lie flat to each other in a plane running substantially perpendicular to the conductor insertion direction of the spring-loaded clamping connection.

9. The conductor terminal according to claim 7, wherein at least part of the support structure is located below the spring arc of the clamping spring and/or extends into the spring arc of the clamping spring.

10. The conductor terminal according to claim 1, wherein one, a number of or all of the mandrels extend through at least one opening of the bus bar arrangement.
